(19) United States
(12) Patent Application Publication
(10) Pub. No.: US 2026/0085744 A1
(43) Pub. Date: Mar. 26, 2026

(54) Actuation system

(71) Applicant: NTN EUROPE, Annecy (FR)

(72) Inventor: GEORGES Etienne, Annecy (FR)

(21) Appl. No.: 19/339,454

(22) Filed: Sep. 25, 2025

(30) Foreign Application Priority Data
Sep. 26, 2024 (FR) 2410311

(51) Int. Cl. F16H 25/22

(52) U.S. Cl. CPC F16H 25/2214

(57) ABSTRACT

The invention relates to an actuation system comprising a nut (1) and a screw (2) of which the respective outer (4) and inner (5) peripheries are provided with threads (4a, 5a) forming a circulation path (7) for rolling bodies (6), one of the screw (2) and the nut (1) having a recirculation path (8) for the rolling bodies (6) to feed the path (7), the path (7) comprises a central portion (7c) disposed between two lateral portions (7a, 7b), the recirculation path (8) having two lateral sections (8a, 8b) extending respectively between a lateral portion (7a, 7b) and said central portion, by being arranged to allow the recirculation of the rolling bodies (6) separately from the central portion (7c) towards one of the lateral portions (7a) for one of the sections (8a) and from the other lateral portion (7b) towards said central portion for the other section (8b).

The invention relates to a system for actuating a mechanical module by linear displacement of an actuating member.

It applies in particular to the actuation of a mechanical module requiring a small displacement of the member but under a high load, such as, for example, a brake caliper of a motor vehicle.

Actuating systems are known which comprise a nut rotatably mounted in a housing, as well as a screw forming an actuating member which is mounted in said nut.

The actuation system is of the “ball screw” type, by having, at the interface between the nut and the screw, a path for circulation of a plurality of rolling bodies, said path being arranged so as to be able to actuate, by rotation of the nut, the axial translation of the screw.

In particular, systems are known in which each of the inner and outer peripheries of respectively the nut and the screw is provided with a helical thread, said threads being arranged radially facing one another to form a helical circulation path for the rolling bodies between two lateral portions of said path.

In a known manner, one of the screw and the nut has a recirculation path for the rolling bodies to feed the circulation path, as the screw moves relative to the nut.

In one embodiment, known as external recirculation, the recirculation path extends continuously between the lateral portions of the circulation path, so as to be able to form an interface with an important axial dimension in order to increase the load capacity of the system.

However, this embodiment requires an important number of rolling bodies which then circulate in the path in the form of a train, the length of which may cause breakages leading to rapid degradation of said path.

The aim of the invention is to improve the prior art by proposing, in particular, an actuation system that is arranged to reconcile load capacity with service life.

To this end, the invention proposes an actuation system comprising a nut and a screw mounted in said nut, by forming an interface between their respective outer and inner peripheries, said interface being equipped with rolling bodies which are arranged so that a rotation of the nut actuates a translation of the screw, each of the outer and inner peripheries of respectively the screw and the nut being provided with a helical thread, said threads being arranged facing each other to form a helical circulation path for the rolling bodies between two lateral portions of said path, one of the screw and the nut having a recirculation path for the rolling bodies to feed the circulation path, the circulation path comprising a central portion disposed between the lateral portions, the recirculation path having two lateral sections extending respectively between one of the lateral portions and said central portion, said lateral sections being arranged to allow recirculation of the rolling bodies separately from the central portion towards one of the lateral portions for one of the sections and from the other lateral portion towards said central portion for the other section.

Other objects and advantages of the invention will become apparent from the following description, made with reference to the attached figures, in which:

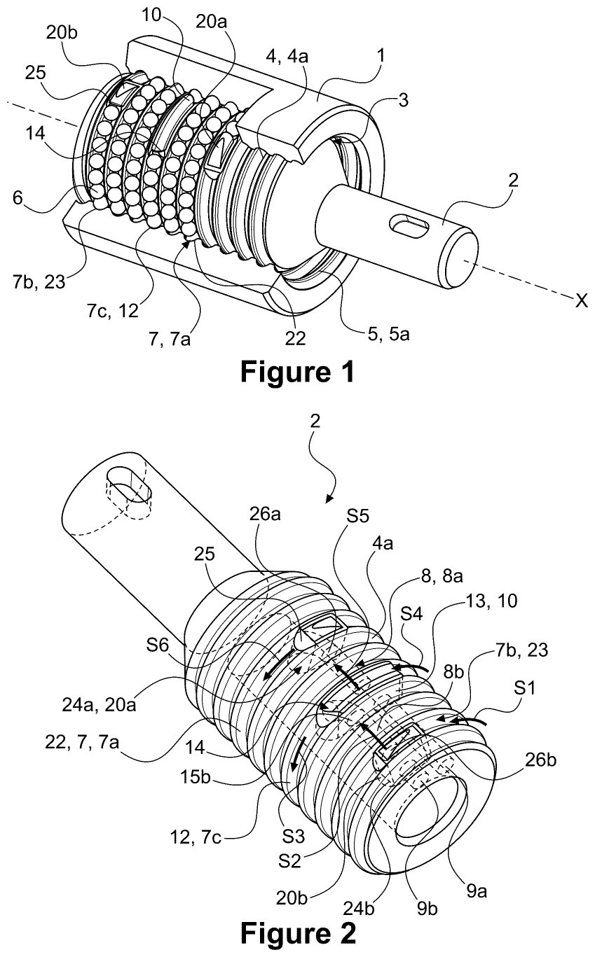

FIG. 1 shows a perspective view of an actuation system according to a first embodiment of the invention, in which the nut is partially cut to show the circulation of the rolling bodies;

FIG. 2 is a perspective view of the screw of the actuation system of FIG. 1, in which the recirculation path of the rolling bodies is shown transparently by means of dotted lines;

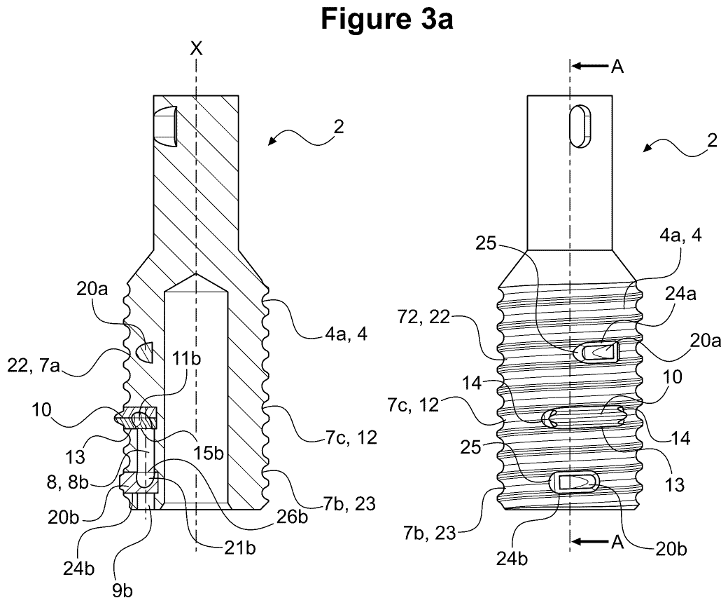

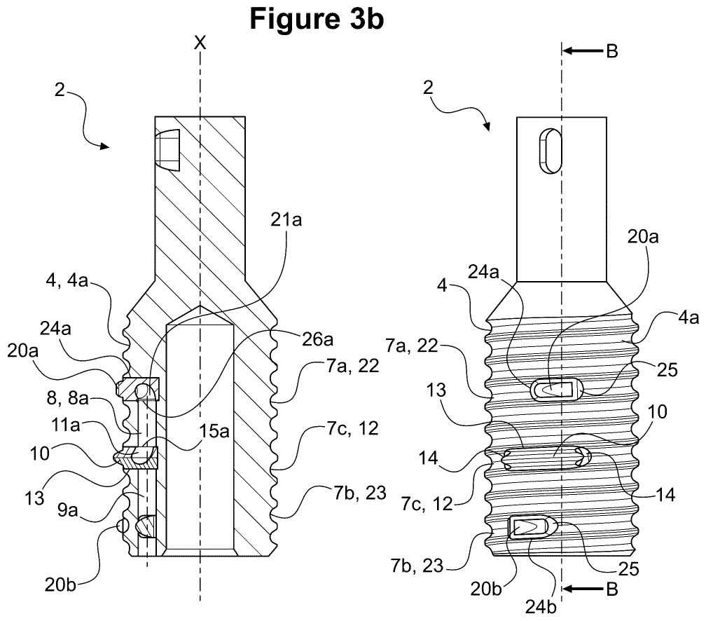

FIG. 3a and

FIG. 3b each show, in top view, the screw of FIG. 2 in a different angular orientation (right), accompanied by a sectional view in a different axial plane (left), respectively plane A-A (for FIG. 3a) and plane B-B (for FIG. 3b);

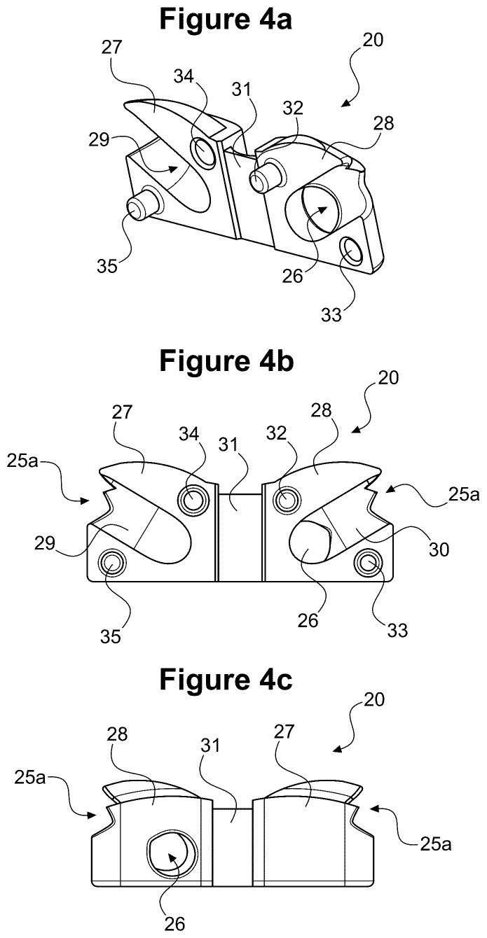

FIG. 4a,

FIG. 4b and

FIG. 4c each represent, in perspective from different orientations, a lateral member for recirculating rolling bodies equipping the system of the preceding figures, and thus before assembly of said lateral member;

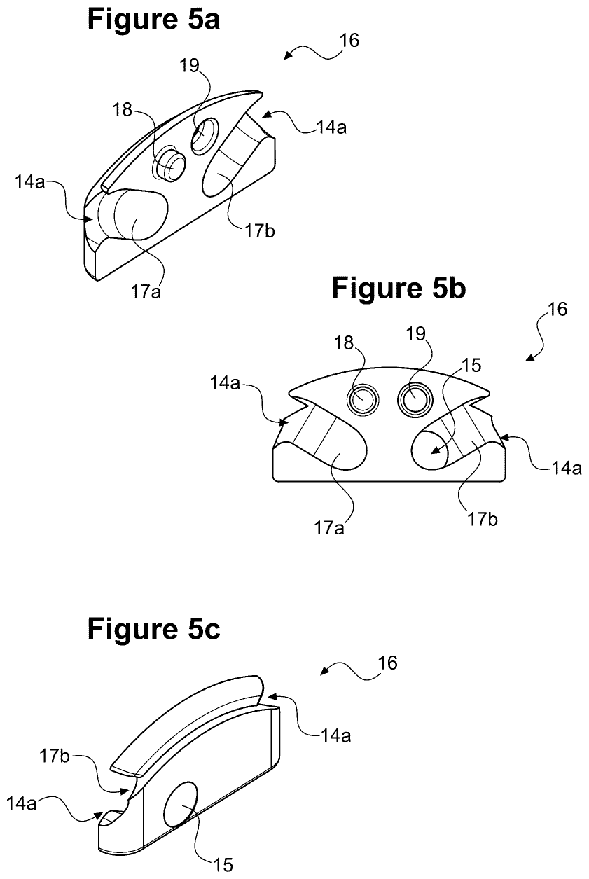

FIG. 5a,

FIG. 5b and

FIG. 5c each represent a shell intended to form the central member equipping the system of the preceding figures, said shell being represented in perspective view from the inside of the recirculation path (FIG. 5a), in front view from the inside of the recirculation path (FIG. 5b) and in perspective view from the outside of said recirculation path (FIG. 5c);

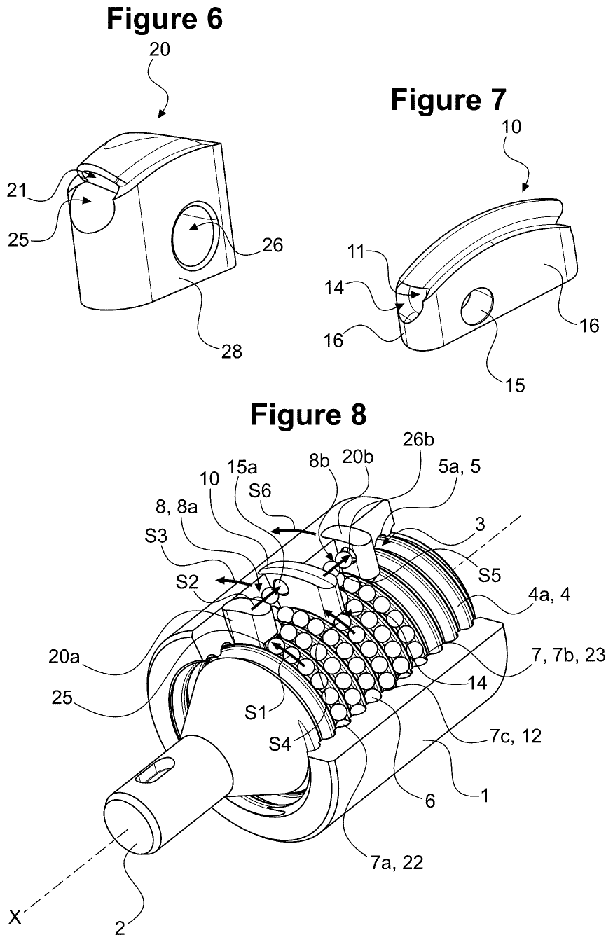

FIG. 6 and

FIG. 7 each show a perspective view of respectively a lateral and central member equipping the system shown in the previous figures;

FIG. 8 shows a perspective view of an actuation system according to a second embodiment of the invention, in which the nut is partially cut to show the circulation of the rolling bodies.

In relation to these figures, a system for actuating a mechanical module by linear displacement of an actuating member is described below, in particular a module requiring a small displacement of the member but under a high load, such as for example a brake caliper for a motor vehicle.

The actuation system comprises a nut 1 rotatably mounted in a housing (not shown), and a screw 2 for actuating said device which is mounted in said nut, by forming a radial interface 3 between the outer periphery 4 of said screw and the inner periphery 5 of said nut.

In the description, the spatial positioning terms are taken with reference to the actuation system as shown in the figures. Thus:
the terms “outer” and “inner” are defined with respect to the axis X of rotation of the nut 1 and displacement of the screw 2, respectively for a location remote from and close to said axis;
the terms “axial” and “radial” are also defined with respect to this axis X, and refer to a direction respectively following this axis X and moving away from or towards it;
the terms “front” and “rear” are defined in relation to the direction of actuation, for a location respectively on the right and on the left in FIG. 1, and respectively on the left and on the right in FIG. 8.

The interface 3 is equipped with rolling bodies 6, for example in the form of spherical balls, which are arranged so that rotation of the nut 1 about the axis X actuates translation of the screw 2 along this same axis X, between a forward deployed position—respectively rearward retracted position—so as to actuate—respectively disengage—the module to be actuated.

In relation to the figures, each of the outer periphery 4 and inner periphery 5 of respectively the screw 2 and the nut 1 is provided with a helical thread 4a, 5a, said threads being arranged radially facing one another to form a helical path 7 for the rolling bodies 6 to circulate between two lateral portions, respectively a front lateral portion 7a and a rear lateral portion 7b, of said path.

One of the screw 2 and the nut 1 has a recirculation path 8 for the rolling bodies 6 to feed the circulation path 7, in order to prevent said rolling bodies from leaving said circulation path during the relative movements of the screw 2 in the nut 1.

FIGS. 1, 2, 3a and 3b show a first embodiment, in which the recirculation path 8 for the rolling bodies 6 is formed in the screw 2. FIG. 8 shows a second embodiment, in which the recirculation path 8 is formed in the nut 1.

The circulation path 7 comprises a central portion 7c disposed between its lateral portions 7a, 7b, the recirculation path 8 having two lateral sections, respectively a front lateral section 8a and a rear lateral section 8b, which extend between one of the lateral portions—respectively the front portion 7a and the rear portion 7b—and the central portion 7c, while being arranged to allow recirculation of the rolling bodies 6 separately from the central portion 7c to one of the lateral portions 7a, 7b for one of the sections 8a, 8b and from the other of said lateral portions to said central portion for the other section 8b, 8a.

In this way, the central portion 7c provides a double return function, by selectively guiding the rolling bodies 6 towards the front or rear of the path 7, depending on the direction of rotation of the nut 1 and therefore of movement of the screw 2. This arrangement makes it possible to limit the length of the train of rolling bodies 6 circulating in the path 7, thus limiting the risks of breakage and/or premature wear of the system, while having an interface 3 of sufficient axial length so that it can accept a significant load.

In relation to FIGS. 2, 3a and 3b, each recirculation section 8a, 8b is formed by a tunnel 9a, 9b which is pierced in the screw 2, as shown, or alternatively in the nut 1 (not visible in FIG. 8), said tunnels each extending in a direction substantially parallel to the axis X of rotation of the nut 1 (and of translation of the screw 2), while being angularly offset in relation to each other. Advantageously, the angular offset between the tunnels 9a, 9b is between 10° and 50°, in particular of the order of 30°.

In the embodiments shown, the central portion 7c is equipped with a central member 10 which has a first duct 11, 11a for guiding the rolling bodies 6 between the circulation path 7 and the front recirculation section 8a, as well as a second separate duct 11, 11b for guiding said rolling bodies between said circulation path and the rear recirculation section 8b.

In relation to FIGS. 2, 3a and 3b, the central portion 7c has a thread 12 which is equipped with a cavity 13, of substantially oblong geometry, formed for that purpose in the screw 2 (as shown) or in the nut 1 (not shown in FIG. 8), and into which the recirculation sections 8a, 8b open out, the central member 10 being disposed in said cavity with the ducts 11a, 11b opening out into the central thread 12 on either side of said member.

In particular, the central thread 12 is formed by a central part of the helical thread 4a of the screw 2, and each duct 11a, 11b has a tangential opening 14 which opens out into said central thread, as well as a lateral opening 15—respectively a front opening 15a and a rear opening 15b—that opens out into the corresponding front section 8a or rear section 8b.

Similarly, each lateral portion 7a, 7b is equipped with a lateral member 20—respectively a front lateral member 20a and a rear lateral member 20b—which has a duct 21, 21a, 21b for guiding the rolling bodies 6 between the circulation path 7 and respectively the front 8a and rear 8b recirculation section.

In the embodiments shown, each lateral portion 7a, 7b has a lateral thread 22, 23 which is equipped with a cavity 24a, 24b, of substantially oblong geometry, and into which the front 8a and rear 8b recirculation section respectively opens out, the corresponding lateral member 20a, 20b being disposed in said cavity with the duct 21a, 21b opening out into said corresponding section, and on one side of said member.

In particular, and similarly to the central portion 7c, each lateral thread 22, 23 is formed by respectively a front and a rear lateral part of the helical thread 4a of the screw 2, and each lateral duct 21a, 21b has a tangential opening 25 which opens out into said lateral thread, as well as a lateral opening 26—respectively a front lateral opening 26a and a rear lateral opening 26b—that opens out into the corresponding front section 8a or rear section 8b.

As shown in particular in FIGS. 2, 3a and 3b, the tunnel 9a for forming the front section 8a opens out axially into each of the cavities 24a, 13 for receiving respectively the central 10 and front 20a members, said members being arranged in their respective cavities 24a, 13 so as to:
placing a front part of the said tunnel, which forms said front section 8a, in axial communication with the front lateral duct 21a and the first central duct 11a;
closing the axial ends of the rear portion of said tunnel.

Similarly, the tunnel 9b for forming the rear section 8b opens out axially into the cavities for receiving the central member 10 and rear member 20b, the latter being arranged in their respective cavities 13, 24b so as to:
placing a front part of said tunnel, which forms said rear section, in axial communication with the second central duct 11b and the rear lateral duct 21b;
axially close the communication between said rear section and the rear end of said tunnel.

In relation to FIG. 2, a direction of circulation/recirculation of the balls 6 is shown for a rearward translation of the screw 2. In particular, the rolling bodies 6 move:
from the rear portion 7b of the path 7: by passing through the tangential opening 25 of the rear member 20b (arrow S1), then opening out into the rear recirculation section 8b via the lateral opening 26b of said member, in order to be routed into the guide duct 11b of the central member 10 (arrow S2), before leaving said central member via the tangential opening 14 of said central guide duct to be recirculated on the central portion 7c of the path 7 (arrow S3) in the direction of the rear member 20b;
from the central portion 7c of the path 7: by passing through the opposite guide duct 11a of the central member 10, into which they enter via the corresponding tangential opening 14 (arrow S4), then opening out into the front recirculation section 8a, via the lateral opening 15a of said guide duct, in order to be routed towards the front lateral member 20a (arrow S5), before leaving the duct 21a of said front member, via its tangential opening 25, in order to be recirculated on the front portion 7a of the path 7 (arrow S6) towards the central member 10.

Following a direction of reverse rotation of the nut 1 and therefore of forward translation of the screw 2, and as shown in FIG. 8, the rolling bodies 6 move:
from the front portion 7a of the path 7: by passing through the tangential opening 25 of the front member 20a (arrow S1), then opening out laterally into the front recirculation section 8a, in order to be routed into the guide duct 11a of the central member 10 (arrow S2), before leaving said central member through the tangential opening 14 of said central guide duct to be recirculated on the central portion 7c of path 7 (arrow S3 towards the front member 20a;
from the central portion 7c of the path 7: by passing through the opposite guide duct 11b of the central member 10, into which they enter via the corresponding tangential opening 14 (arrow S4), then opening out laterally into the rear recirculation section 8b, in order to be routed towards the rear lateral member 20b (arrow S5), before leaving the duct 21b of said rear member, via its tangential opening 25, in order to be recirculated on the rear portion 7b of the path 7 (arrow S6) towards the central member 10.

In the embodiments shown, the central member 10 has a body in which the two guide ducts 11a, 11b are formed on either side.

Referring to FIGS. 5a, 5b, 5c and 7, the body of the central member 10 is formed by assembling two shells 16, each of said shells having a print 17a, 17b of a part of each of the ducts 11a, 11b.

Advantageously, the shells 16 have an identical arrangement, in particular by being obtained by moulding from a polymer material, which facilitates their manufacture, in particular by means of a single mould, and therefore reduces the production costs of the actuation system.

In particular, each print 17a, 17b has a part 14a of a tangential opening 14 of the corresponding duct 11a, 11b, and one of the print 17b is traversed by a lateral opening 15 of the corresponding duct 11a, 11b.

In addition, each shell 16 incorporates means of reciprocal association with the other shell 16, said means comprising a pin 18 and a complementary blind orifice 19 intended to cooperate by fitting respectively with the orifice 19 and the pin 18 of the other shell 16.

Similarly, and as shown in FIGS. 4a, 4b, 4c and 6, each lateral member 20a, 20b is formed by assembling two shells 27, 28, each of said shells having a print 29, 30 of a part of the duct 21a, 21b.

Advantageously, the two shells 27, 28 are joined in one piece by a bridge of material 31, said piece being obtained by moulding a polymer material, said bridge of material being allowed to be folded to allow said shells to be assembled. In addition, each lateral member 20a, 20b may be produced from such identical pieces.

As previously indicated in relation to the central member 10, this arrangement allows to facilitate the manufacture of the lateral members 20a, 20b, in particular from a single mould allowing axial demoulding.

As shown in FIGS. 4a to 4c, each cavity 29, 30 has a part 25a of the tangential opening 25 of the corresponding lateral duct 21a, 21b, and one of the prints 30 has the lateral opening 26 of said duct passing through it.

In addition, each shell 27, 28 incorporates means of reciprocal association with the other shell 28, 27. To do this, one of the shells 27 has an upper pin 32 and a lower blind orifice 33 intended to cooperate by fitting with respectively an upper blind orifice 34 and a lower pin 35 of complementary geometries formed on the other shell 28 during assembly of the member 20, 20a, 20b by folding the bridge 31 connecting said shells.

1. Actuation system comprising a nut (1) and a screw (2) mounted in said nut, by forming an interface (3) between their respective outer (4) and inner (5) peripheries, said interface being equipped with rolling bodies (6) which are arranged so that a rotation of the nut (1) actuates a translation of the screw (2), each of the outer (4) and inner (5) peripheries of respectively the screw (2) and the nut (1) being provided with a helical thread (4a, 5a), said threads being arranged facing one another to form a helical circulation path (7) for the rolling bodies (6) between two lateral portions (7a, 7b) of said path, one of the screw (2) and the nut (1) having a recirculation path (8) for the rolling bodies (6) in order to feed the circulation path (7), said actuation system being characterized in that the circulation path (7) comprises a central portion (7c) arranged between the lateral portions (7a, 7b), the recirculation path (8) having two lateral sections (8a, 8b) extending respectively between one of the lateral portions (7a, 7b) and said central portion, said lateral sections being arranged to allow the recirculation of the rolling bodies (6) separately from the central portion (7c) towards one of the lateral portions (7a) for one of the sections (8a) and from the other lateral portion (7b) towards said central portion for the other section (8b).

2. Actuation system according to claim 1, characterised in that the central portion (7c) is equipped with a central member (10) having a first duct (11a) for guiding the rolling bodies (6) between the circulation path (7) and the first recirculation section (8a), and a second duct (11b) for guiding the rolling bodies (6) between the circulation path (7) and the second recirculation section (8b).

3. Actuation system as claimed in claim 2, characterised in that the central member (10) has a body in which the two guide ducts (11a, 11b) are formed on either side.

4. Actuation system according to claim 2, characterised in that the central portion (7c) has a thread (12) equipped with a cavity (13) into which the recirculation sections (8a, 8b) open out, the central member (10) being arranged in said cavity with the ducts (11a, 11b) opening out into said thread on one side and on the other of said member.

5. Actuation system according to claim 2, characterised in that each of the ducts (11a, 11b) has a tangential opening (14) that opens out into the circulation path (7) and a lateral opening (15, 15a, 15b) that opens out into a recirculation section (8a, 8b).

6. Actuation system according to claim 2, characterised in that the central member (10) is formed by the assembly of two shells (16), each of said shells having a print (17a, 17b) of a part of each of the ducts (11a, 11b).

7. Actuation system according to claim 6, characterised in that the two shells (16) are identical, in particular by being obtained by moulding a polymer material.

8. Actuation system according to claim 1, characterised in that each of the recirculation sections (8a, 8b) is formed by a tunnel (9a, 9b) pierced in the screw (2) or in the nut (1), said tunnels being angularly offset.

9. Actuation system according to claims 1, characterised in that each of the lateral portions (7a, 7b) is equipped with a lateral member (20, 20a, 20b) having a duct (21, 21a, 21b) for guiding the rolling bodies (6) between the circulation path (7) and one of the recirculation sections (8a, 8b).

10. Actuation system according to claim 9, characterised in that each of the lateral portions (7a, 7b) has a thread (22, 23) equipped with a cavity (24a, 24b) into which a recirculation section (8a, 8b) opens out, the corresponding lateral member (20a, 20b) being disposed in said cavity with the duct (21a, 21b) opening out into said section on one side of said member.

11. Actuation system according to claim 9, characterised in that each of the lateral ducts (21a, 21b) has a tangential opening (25) that opens out into the circulation path (7) and a lateral opening (26, 26a, 26b) that opens out into a recirculation section (8a, 8b).

12. Actuation system according to claim 9, characterised in that each of the lateral members (20, 20a, 20b) is formed by the assembly of two shells (27, 28), each of said shells having a print (29, 30) of a part of the duct (21, 21a, 21b).

13. Actuation system according to claim 12, characterized in that the two shells (27, 28) are joined in one piece by a bridge of material (31), in particular by being obtained by moulding a polymer material said bridge of material being allowed to be folded to allow said shells to be assembled.
